(19) United States
(12) Patent Application Publication
(10) Pub. No.: US 2011/0050861 A1
(43) Pub. Date: Mar. 3, 2011

(54) STEREOSCOPIC IMAGE DISPLAY DEVICE AND STEREOSCOPIC IMAGE DISPLAY METHOD

(75) Inventors: Tsutomu SAKAMOTO, Ome-shi (JP); Masahiro YAMADA, Nishitama-gun (JP)

(73) Assignee: KABUSHIKI KAISHA TOSHIBA, Tokyo (JP)

(21) Appl. No.: 12/797,429

(22) Filed: Jun. 9, 2010

(30) Foreign Application Priority Data
Aug. 31, 2009 (JP) 2009-201064

(51) Int. Cl. H04N 13/04

(52) U.S. Cl. 348/51; 348/E13.074

(57) ABSTRACT

According to one embodiment, a stereoscopic image display device obtains a substantially greater value of a maximum value of luminous when displaying a first stereoscopic image and a maximum value of luminous when displaying a second stereoscopic image in each of plural areas divided from a display panel surface corresponding to plural light sources which illuminate the display panel thereby to control the emitted light amount of the light source corresponding to the area.

### CROSS-REFERENCE TO RELATED APPLICATIONS

This application is based upon and claims the benefit of priority from Japanese Patent Application No. 2009-201064, filed Aug. 31, 2009, the entire contents of which are incorporated herein by reference.

### BACKGROUND

1. Field

One embodiment of the invention relates to improvement of a stereoscopic image display device and a stereoscopic image display method capable of displaying a stereoscopic image by applying illumination light from a backlight to a liquid crystal display panel or the like.

2. Description of the Related Art

As is well known, there has been developed a technique of making a user recognize a stereoscopic image with use of a planer image display screen. In this technique, stereoscopic vision is obtained by preparing two images with parallax corresponding to the distance between the eyes, making the right eye recognize a right-eye image and the left eye recognize a left-eye image.

Specifically, there exists a technique of making a user recognize a stereoscopic image by displaying right- and left-eye images on the same image display screen alternately and controlling a pair of stereoscopic glasses the user wears in such a manner that a left-eye shutter is closed when the right-eye image is displayed and a right-eye shutter is closed when the left-eye image is displayed.

Meanwhile, there has recently been a rapid spread of an image display device using a liquid crystal display panel for displaying images. This type of image display device displays images by allowing illumination light from a backlight, which has a cold-cathode tube such as a discharge lamp or a fluorescent tube as a light source, to pass through the liquid crystal display panel from its backside.

At present, there is developed a local dimming technique of making the backlight of a plurality of light sources and controlling the emitted light amount of each light source in accordance with partial brightness of the display image on the same screen to make a dark part darker and a bright part brighter on the same screen thereby enhancing the contrast.

With development of this local dimming technique, needless to say, it is considered that stereoscopic images are displayed using an image display device to which the local dimming technique is applied. However, such a local dimming technique is still developing and has room for improvement at various points when being used in displaying images for stereophonic vision.

For example, the right- and left-eye images displayed alternately for stereoscopic vision have mutual parallax and when small areas at the same position in the respective images are compared, there sometimes exists the same subject and sometimes not. In this case, if the luminous of the subject is high, a high-luminous image and a low-luminous image are displayed alternately for the small areas.

Here, consideration is given to the emitted light amount of each of plural light sources that make up the above-mentioned backlight. Specifically, each light source for applying illumination light to the above-mentioned small area is controlled to emit much light (be brighter) when displaying of an image in which the subject exists and emit less light (be darker) when displaying of an image in which no subject exists.

However, the emitted light amount of each of the plural light sources that make up the backlight is controlled to change slowly in the time axis direction in order to prevent the user from recognizing sequential transition of the light emission of the light source in accordance with the motion of the display image when displaying of a typical moving image.

Therefore, the light source for applying the illumination light to the above-mentioned small area is controlled to emit light at the approximately intermediate amount between the emitted light amount when displaying the image with the subject and the emitted light amount when displaying the image with no subject, which sometimes makes the user feel that the display image is dark.

Jpn. Pat. Appln. KOKAI Publication No. 2007-279395 discloses a structure in which a luminous value of an image displayed on each of a plurality of display areas divided from a display screen is obtained, a peak luminous value of each of the display areas is detected and the brightness of illumination light applied from illuminating means which illuminates the image displayed on the display screen is controlled per display area in accordance with the peak luminous value.

Jpn. Pat. Appln. KOKAI Publication No. 2008-268396 discloses a structure in which display means is provided which has a plurality of unit display areas arranged for displaying first and second images with parallax for stereoscopic viewing, and a monochromatic image of each of plural color components that make each of the first and second images is sequentially displayed per one or more unit display areas out of the plural unit display areas.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating one embodiment of the present invention and for explaining one example of a signal processing system of a stereoscopic image display device;

FIG. 2 is a view for explaining one operation example of a serial processing module of the stereoscopic image display device according to the embodiment;

FIG. 3 is a timing chart for explaining one example of the relationship between right- and left-eye images displayed on the stereoscopic image display device according to the embodiment and shutter control of a pair of stereoscopic glasses;

FIG. 4 is a plan view for explaining one example of a liquid crystal display panel of the stereoscopic image display device according to the embodiment;

FIG. 5 is a plan view for explaining one example of a backlight of the stereoscopic image display device according to the embodiment;

FIG. 6 is a side view for explaining one example of the relationship between the backlight and the liquid crystal display panel of the stereoscopic image display device according to the embodiment;

FIG. 7 is a block diagram for explaining one example of a backlight controller of the stereoscopic image display device according to the embodiment;

FIG. 8 is a block diagram for explaining one example of a control value storage and an all-area maximum value storage that make up the backlight controller according to the embodiment;

FIG. 9 is a block diagram for explaining one example of an LPF of the backlight controller according to the embodiment;

FIG. 10 is a characteristic view for explaining one example of filtering processing in the time axis direction of the LPF according to the embodiment;

FIG. 11 is a view for explaining one example of a right-eye image displayed on the stereoscopic image display device according to the embodiment and a lighting state of the backlight;

FIG. 12 is a view for explaining one example of a left-eye image displayed on the stereoscopic image display device according to the embodiment and a lighting state of the backlight;

FIG. 13 is a view for explaining one example of an image generated by the stereoscopic image display device according to the embodiment and a lighting state of the backlight;

FIG. 14 is a block diagram for explaining a modification of the stereoscopic image display device according to the embodiment;

FIG. 15 is a timing chart for explaining an example of the operation performed by the modification of the stereoscopic image display device according to the embodiment; and

FIG. 16 is a timing chart for explaining another example of the operation performed by the modification of the stereoscopic image display device according to the embodiment.

### DETAILED DESCRIPTION

Various embodiments according to the invention will be described hereinafter with reference to the accompanying drawings. In general, according to one embodiment of the invention, astereoscopic image display device obtains a substantially greater value of a maximum value of luminous when displaying a first stereoscopic image and a maximum value of luminous when displaying a second stereoscopic image in each of plural areas divided from a display panel surface corresponding to plural light sources which illuminate the display panel thereby to control the emitted light amount of the light source corresponding to the area.

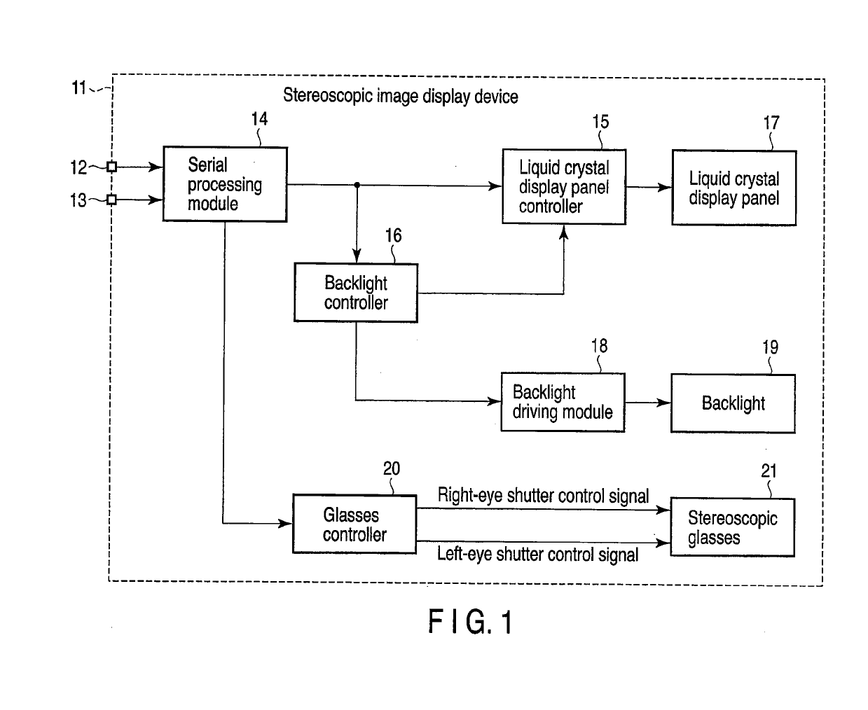

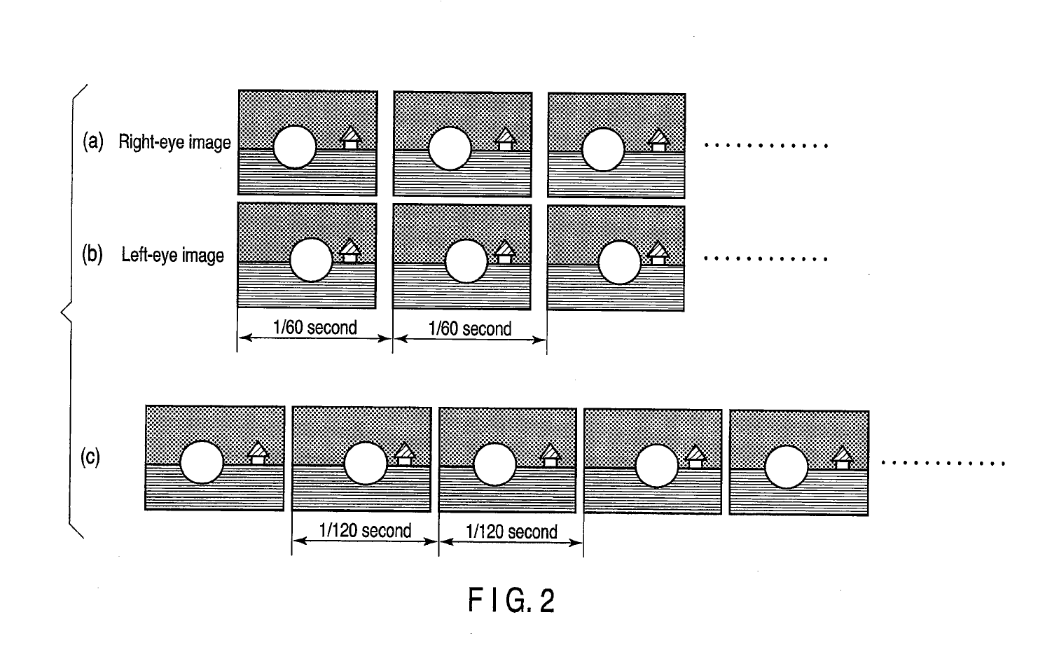

FIG. 1 illustrates a signal processing system of a stereoscopic image display device 11 explained in this embodiment. This stereoscopic image display device 11 comprises two input terminals 12 and 13. The input terminal 12 receives a right-eye image signal to form a right-eye image at the frame period of 1/60 second, as illustrated in (a) of FIG. 2. In addition, the other input terminal 13 receives a left-eye image signal to form a left-eye image at the frame period of 1/60 second, as illustrated in (b) of FIG. 2.

These right- and left-eye image signals can be obtained, for example, by receiving what a broadcasting company transmits as a stereoscopic image signal. In addition, they can be also obtained from a contents provider via network or the like or reproduction from a recording medium such as an optical disk.

The right- and left-eye image signals supplied to these input terminals 12 and 13 are supplied to a serial processing module 14. This serial processing module 14 receives these right- and left-eye image signals supplied to the input terminals 12 and 13 and outputs signals in such a manner that they are arranged alternately per frame at the frame period of 1/120 second, as illustrated in (c) of FIG. 2. The image signal output from the serial processing module 14 is supplied to a liquid crystal display panel controller 15 and a backlight controller 16.

The liquid crystal panel controller 15 controls to form a display image of one frame on a later-stage liquid crystal display panel 17 by writing an image signal corresponding to the one frame output from the serial processing module 14 in plural pixels that make up the liquid crystal display panel 17.

In addition, the above-mentioned backlight controller 16 controls a later-stage backlight 19 that performs image display by applying illumination light to the back surface side of the liquid crystal display panel 17. That is, this backlight controller 16 uses the image signal output from the serial processing module 14 as a basis to calculate an emitted light amount control value so as to control the emitted light amount (brightness) of each of plural light sources that make up the backlight 19 to correspond to partial luminous of the display image of one frame formed on the liquid crystal display panel 17.

Then, the emitted light amount control value calculated by this backlight controller 16 is supplied to a backlight driving module 18. This backlight driving module 18 uses the emitted light amount control value supplied from the backlight controller 16 as a basis to control the emitted light amount of each of the plural light sources that make up the backlight 19 thereby to perform image display to which the local dimming technique is applied.

Here, the above-described liquid crystal display panel controller 15 is supplied with the emitted light amount control value calculated by the backlight controller 16. Then, the liquid crystal display panel controller 15 performs correction processing based on the emitted light amount control value calculated by the backlight controller 16 on the image signal output from the serial processing module 14 and outputs the signal to the liquid crystal display panel 17.

In addition, the above-mentioned serial processing module 14 outputs to a glasses controller 20 a signal indicating a timing of outputting right- and left-eye image signals alternately on a frame-by-frame basis. This glasses controller 20 uses the timing signal supplied from the serial processing module 14 as a basis to generate a right-eye shutter control signal and a left-eye shutter control signal for a pair of stereoscopic glasses 21 the user wears.

That is, this glasses controller 20 controls to close the left-eye shutter of the stereoscopic glasses 21 when the right-eye image is displayed and close the right-eye shutter of the stereoscopic glasses 21 when the left-eye image is displayed. This control makes the user recognize the stereoscopic image.

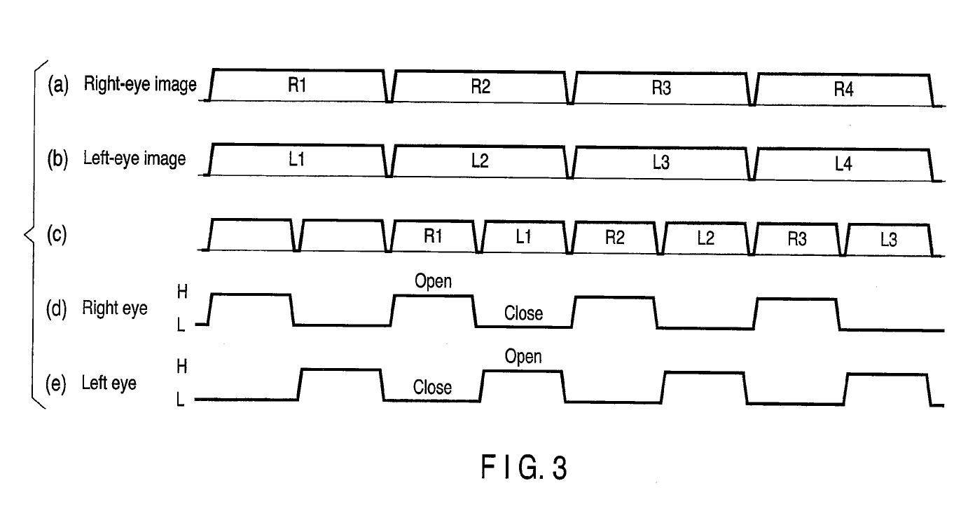

FIG. 3 illustrates the relationship between the right- and left-eye images displayed on the liquid crystal display panel 17 and the right- and left-eye shutter control of the stereoscopic glasses 21. Here, it is assumed that right-eye image signals R1, R2, . . . at the frame period of 1/60 second as illustrated in (a) of FIG. 3 are supplied to the above-mentioned input terminal 12 and the left-eye image signals L1, L2, . . . at the frame period of 1/60 second as illustrated in (b) of FIG. 3 are supplied to the above-mentioned input terminal 13.

Then, the serial processing module 14 outputs, as illustrated in (c) of FIG. 3, right- and left-eye image signals alternately at the frame period of 1/120 second, based on which the right- and left-eye images are displayed alternately on the liquid crystal display panel 17.

Then, as illustrated in (d) of FIG. 3, the above-mentioned glasses controller 20 outputs a right-eye shutter control signal to open the right-eye shutter of the stereoscopic glasses 21 at the high level occurring when the right-eye image is displayed and close the right-eye shutter of the stereoscopic glasses 21 at the low level occurring when the left-eye image is displayed.

In addition, as illustrated in (e) of FIG. 3, the glasses controller 20 outputs a left-eye shutter control signal to open the left-eye shutter of the stereoscopic glasses 21 at the high level occurring when the left-eye image is displayed and close the left-eye shutter of the stereoscopic glasses 21 at the low level occurring when the right-eye image is displayed.

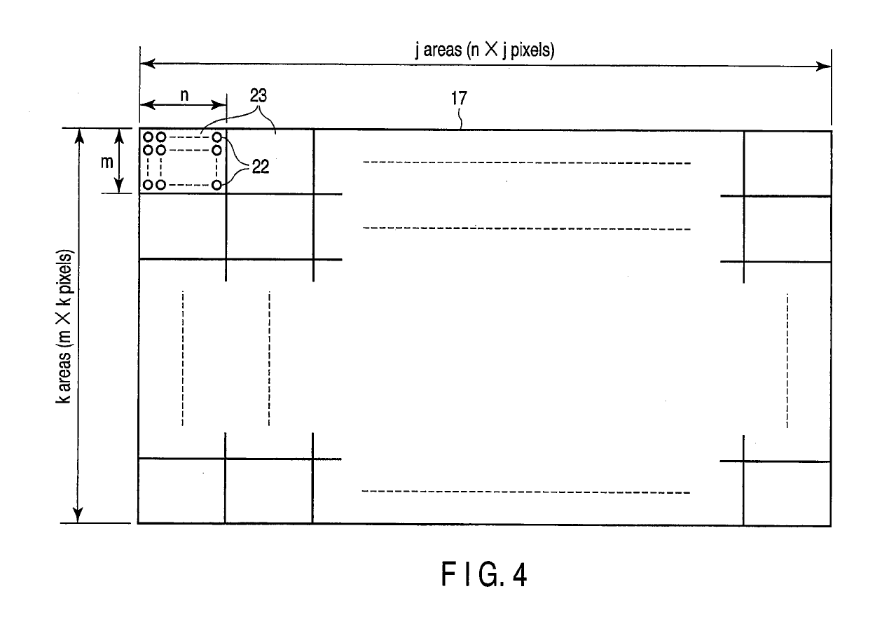

Here, FIG. 4 illustrates one example of the above-described liquid crystal display panel 17. Specifically, this liquid crystal display panel 17 is configured to have a plurality of pixels 22, each of which is a liquid crystal cell, arranged in the horizontal and vertical directions into a matrix shape. In this case, a panel surface of the liquid crystal display panel 17 is divided into a plurality of areas (j×k areas) 23 arranged to have j areas in the horizontal direction and k areas in the vertical direction. Each of the areas 23 includes a plurality of pixels (n×m pixels) 22 arranged to have n pixels in the horizontal direction and m pixels in the vertical direction.

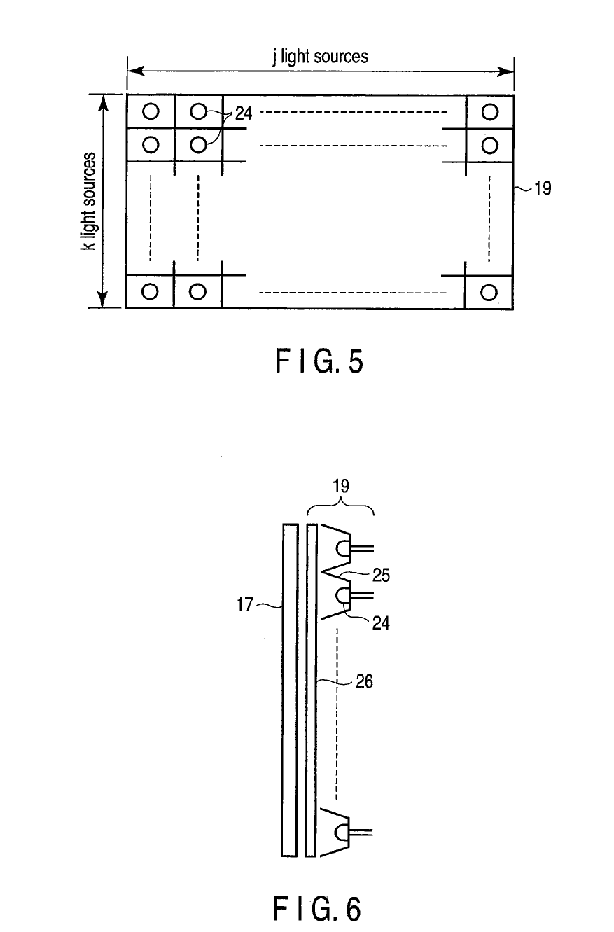

Further, FIG. 5 illustrates one example of the above-mentioned backlight 19. Specifically, the backlight 19 has a plurality of light sources (j×k) 24 arranged in a matrix shape in such a manner that there are j light sources in the horizontal direction and k light sources in the vertical direction, corresponding to the respective areas 23 of the above-mentioned liquid crystal display panel 17. Each of these light sources 24 is an LED (light emitting diode) or the like.

More specifically, as illustrated in FIG. 6, the backlight 19 comprises light sources 24, such as white LED array, which are arranged to have j light sources in the horizontal direction and k light sources in the vertical direction. Each of the light sources 24 is covered with a light reflector 25, and a diffusing plate 26 is arranged on the irradiation surface of the light so that even light irradiation can be achieved on each area 23. Then, this backlight 19 is placed on the back surface side of the liquid crystal display panel 17 and radiates light to the back surface of the liquid crystal display panel 17 so as to display images.

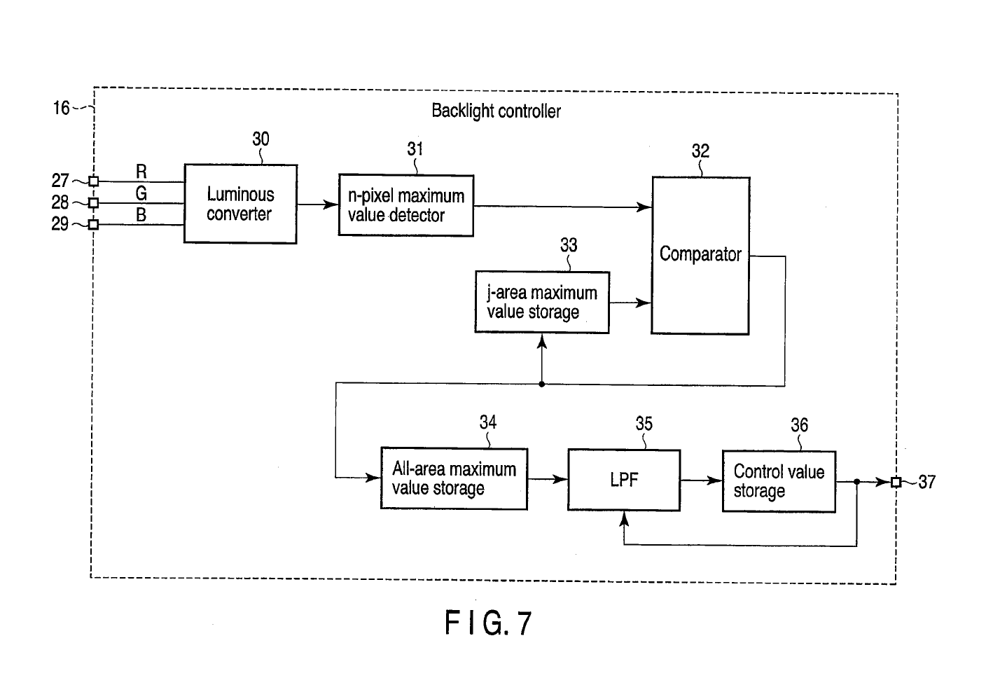

FIG. 7 illustrates an example of the above-mentioned backlight controller 16. This backlight controller 16 comprises input terminals 27, 28 and 29 which are supplied with red (R), green (G) and blue (B) image signals, respectively, output from the serial processing module 14. These R, G and B signals supplied to the input terminals 27 to 29 are input to a luminous converter 30, in which they are converted to a luminous signal Y.

The luminous signal Y output from this luminous converter 30 is supplied to an n-pixel maximum value detector 31. This n-pixel maximum value detector 31 detects a maximum value of luminous in each area 23, which is each n pixels out of plural (n×j) pixels that make up one horizontal line, and output its resultant value to one input terminal of a comparator 32.

Once the n-pixel maximum value detector 31 detects the maximum value of luminous for each of the j areas in the one horizontal line, the n-pixel maximum value detector 31 then detects a maximum value of luminous for each area 23, that is, each n pixels out of plural (n×j) pixels that make up the next horizontal line and repeats this operation.

Further, the other input terminal of the above-mentioned comparator 32 is supplied with values of luminous stored in a j-area maximum value storage 33. This j-area maximum value storage 33 has luminous maximum value storage areas corresponding to j areas 23 arranged in the horizontal direction. Then, the comparator 32 compares a maximum value of luminous of a given area 23 supplied from the n-pixel maximum value detector 31 with a value of luminous read from a luminous maximum value storage area of the j-area maximum value storage 33 corresponding to the given area 23, selects a substantially greater value of them and stores the value in the same luminous maximum value storage area of the j-area maximum value storage 33.

In this case, it is assumed that the value of luminous stored in the j-area maximum value storage 33 to be compared with the maximum value of luminous detected in the first horizontal line in each area 23 by the n-pixel maximum value detector 31 is “0”, and a comparison result in the same area 23 obtained by the comparator 32 is stored in the luminous maximum value storage area of the corresponding area 23 in the j-area maximum value storage 33.

Then, when the processing of detecting the maximum values of luminous for the j areas 23 in the m horizontal lines by the n-pixel maximum value detector 31 is finished, during its detection processing, the comparator 32 outputs a maximum value of luminous of each of the j areas 23 in the horizontal direction.

In this way, the maximum values of luminous in the j areas 23 in the horizontal direction output from the comparator 32 are written in the all-area maximum value storage 34.

The operation described up to this point is repeated k times in the vertical direction so that maximum values of luminous in all of the j×k areas 23 in the liquid crystal display panel 17 are obtained and written in the all-area maximum value storage 34.

Then, the maximum values of luminous in all of the areas 23 written in the all-area maximum value storage 34 are subjected to the filtering processing in the time axis direction by a low-pass filter (LPF) 35 and then, written in the control value storage 36 as emitted light amount control values to control the emitted light amounts of the plural (j×k) light sources 24 that make up the above-mentioned backlight 19.

Then, the emitted light amount control value of each of the light sources 24 written in this control value storage 36 is supplied to the backlight driving module 18 via the output terminal 37.

Here, the above-mentioned LPF 35 performs the filtering processing, based on the previous emitted light amount control values written in the control value storage 36, on the maximum values of luminous supplied from the all-area maximum value storage 34.

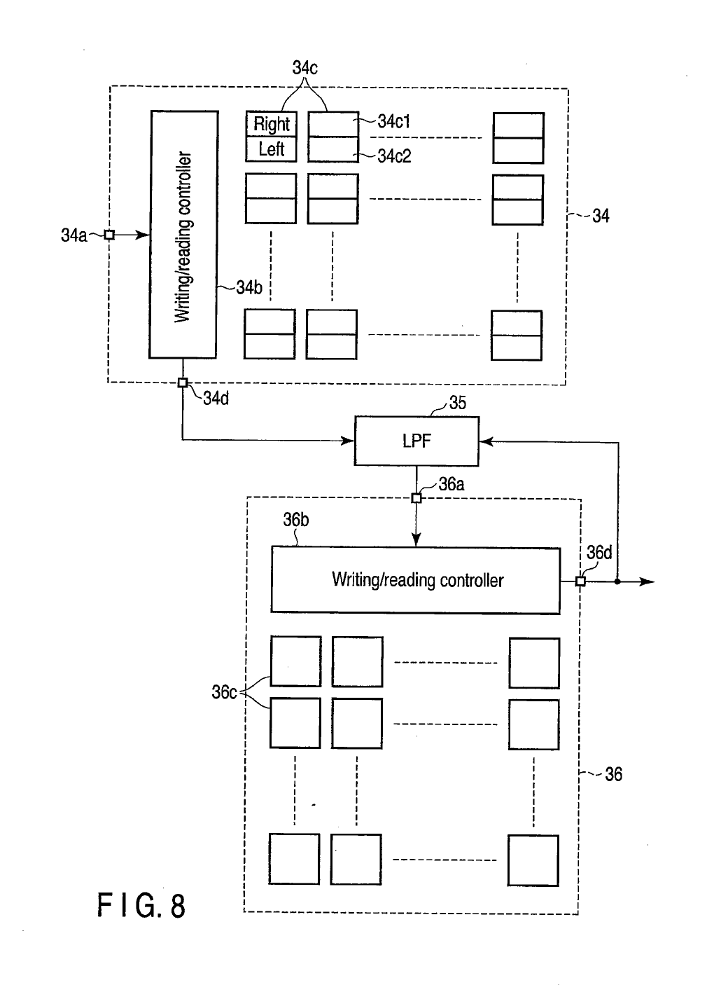

FIG. 8 illustrates an example of the all-area maximum value storage 34 and the control value storage 36. That is, in the all-area maximum value storage 34, maximum values of luminous of the areas 23 output from the comparator 32 are supplied to an input terminal 34a. The maximum values of luminous supplied to this input terminal 34a are supplied to a writing/reading controller 34b and stored, on a per-area basis, in plural (j×k) maximum value storages 34c which are arranged to have j storages in the horizontal direction and k storages in the vertical direction corresponding to the respective areas 23.

In this case, each of the maximum value storages 34c comprises a right-eye maximum value storage area 34c1 to store the maximum value of luminous of a corresponding area 23 for the right-eye image and a left-eye maximum value storage area 34c2 to store the maximum value of luminous of the corresponding area 23 for the left-eye image.

Therefore, in the right-eye maximum value storage area 34c1 and the left-eye maximum value storage area 34c2 of each of the maximum value storages 34c, the maximum values of luminous of the corresponding area 23 in the one-frame right- and left-eye image signals output alternately from the serial processing module 14 are stored.

Then, the above-mentioned writing/reading controller 34b selects a substantially greater value out of maximum values of luminous stored in the left-eye maximum value storage area 34c2 and the right-eye maximum value storage area 34c1 of each of the maximum value storages 34c and outputs it to the LPF 35 via the output terminal 34d.

This LPF 35 performs the filtering processing in the time axis direction based on the previous emitted light amount control values written in the control value storage 36 on the maximum values of luminous of the respective areas 23 output from the all-area maximum value storage 34, and outputs the values to the control value storage 36.

In this case, in the above-mentioned control value storage 36, a maximum value of luminous at each area 23 output from the LPF 35 is supplied to the input terminal 36a. This maximum value of luminous, which is subjected to the filtering processing and supplied to the input terminal 36a, is supplied to a writing/reading controller 36b. Then, the value is stored as an emitted light amount control value, on a per-area basis, in a corresponding one of the plural (j×k) emitted light amount storages 36c arranged in such a manner that there are j storages in the horizontal direction and k storages in the vertical direction corresponding to the respective areas 23.

Then, the writing/reading controller 36b outputs the emitted light amount control value stored in each of the emitted light amount control value storages 36c via the output terminal 36d to the above-mentioned backlight driving module 37 and to the LPF 35. In this case, the backlight driving module 37 uses the emitted light amount control value read from each emitted light amount control value storage 36c as a basis to control the emitted light amount of the light source 24 of the corresponding area 23.

That is, in the backlight controller 16 illustrated in FIG. 7, a maximum value of luminous in the right-eye image and a maximum value of luminous in the left-eye image are obtained for each of plural (j×k) areas 23 divided from the panel screen of the liquid crystal display panel 17. Then, a substantially greater value of the maximum values of luminous in the left- and right-eye images is selected and set as an emitted light amount control value for controlling the emitted light amount of the light source 24 of the corresponding area 23.

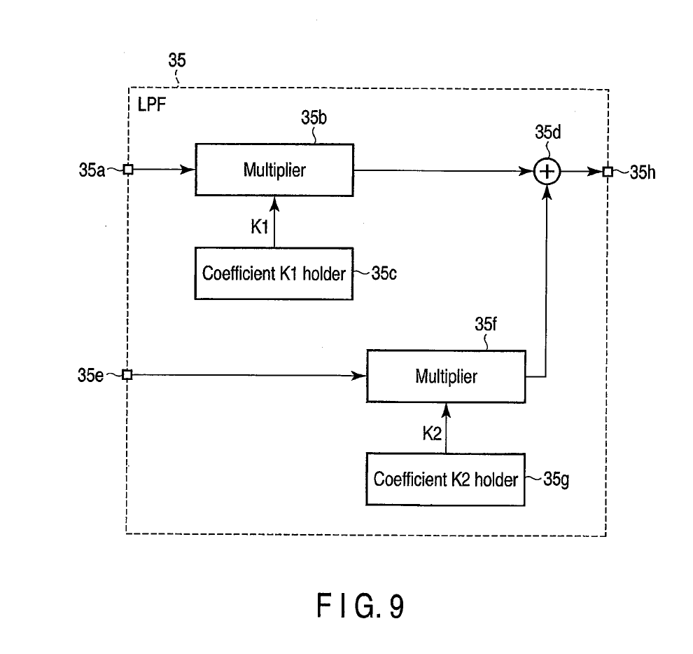

Here, before explaining a reason why the above-mentioned operation is performed by the backlight controller 16, one example of the LPF 35 is explained with reference to FIG. 9. The LPF 35 is supplied at an input terminal 35a with maximum values of luminous of respective areas 23 output from the all-area maximum value storage 34. Each of the maximum values of luminous supplied to this input terminal 35a is supplied to a multiplier 35b, multiplied by a coefficient K1 held in a coefficient K1 holder 35c and supplied to an input terminal of an adder 35d.

Further, the LPF 35 is supplied at an input terminal 35e with emitted light amount control values for the light sources 24 per area 23 stored in the control value storage 36. Each of the emitted light amount control values supplied to the input terminal 35e is supplied to a multiplier 35f, multiplied by a coefficient K2 held in a coefficient K2 holder 35g and then supplied to the other input terminal of the adder 35d.

Then, the adder 35d adds the luminous value output from the multiplier 35b and the emitted light amount control value output from the multiplier 35f of the same area 23a and outputs the resultant value as a new emitted light amount control value to the control value storage 36 via an output terminal 35h. Therefore, the control value storage 36 writes and holds the emitted light amount control value supplied from the LPF 35, in the emitted light amount control value storage 36c of the corresponding area 23.

The operation of the LPF 35 is described by way of a specific example of the one given area 23. It is assumed that the coefficient K1 is 0.4 and the coefficient K2 is 0.6. When the value supplied to the input terminal 35a is changed from 0 to 1, its input value is multiplied by 0.4. Then, if an emitted light amount control value supplied from a corresponding emitted light amount control value storage 36c of the control value storage 36 to the input terminal 35e is 0, an output from the adder 35d becomes 0.4, which is stored in the corresponding emitted light amount control value storage 36c of the control value storage 36 as a new emitted light amount control value.

In the next same area 23, a value 1 supplied to the input terminal 35a is multiplied by 0.4 at the multiplier 35b. At this time, an emitted light amount control value supplied from the corresponding emitted light amount control value storage 36c of the control value storage 36 to the input terminal 35e is 0.4 stored previously. Therefore, 0.4 output from the multiplier 35b and 0.24 obtained by multiplying 0.4 supplied to the input terminal 35e by 0.6 at the multiplier 35f are added at the adder 35d to result in 0.64. Then, this value of 0.64 is stored in the corresponding emitted light amount control value storage 36c of the control value storage 36 as a new emitted light amount control value.

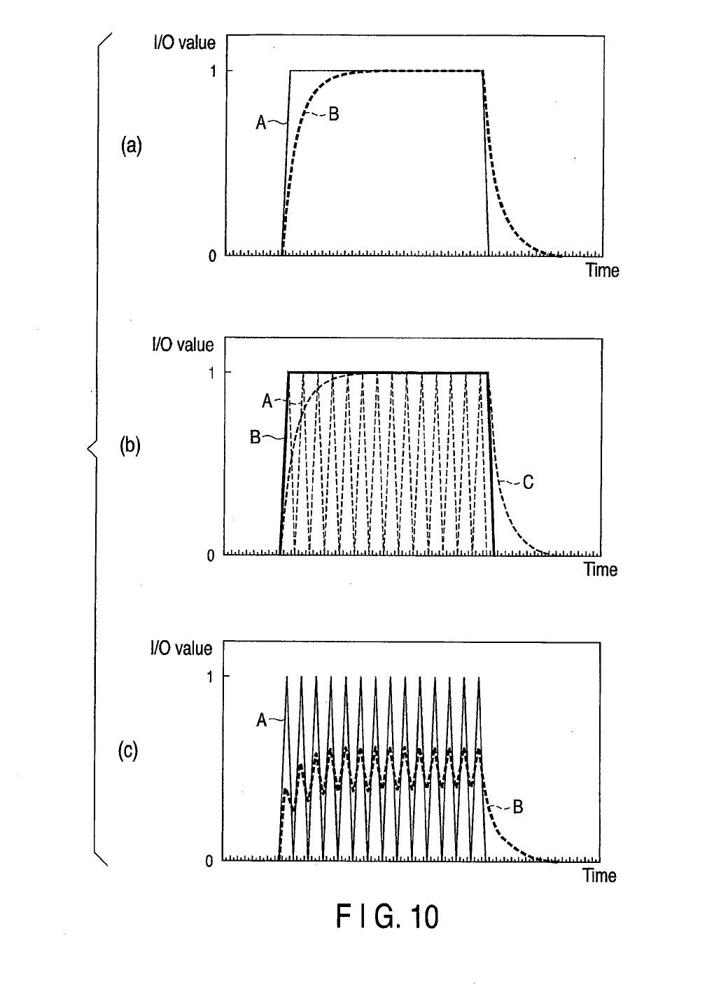

Through repetition of such an operation, as denoted by the solid line A in (a) of FIG. 10, when the value supplied to the input terminal 35a is changed from 0 to 1, a value output from the LPF 35 becomes a value that shows gradual increase as denoted by the dotted line B in (a) of FIG. 10, that is, a value subjected to the filtering processing in the time axis direction.

Likewise, if the value supplied to the input terminal 35a is changed from 1 to 0, an output value from the LPF 35 shows gradual decrease.

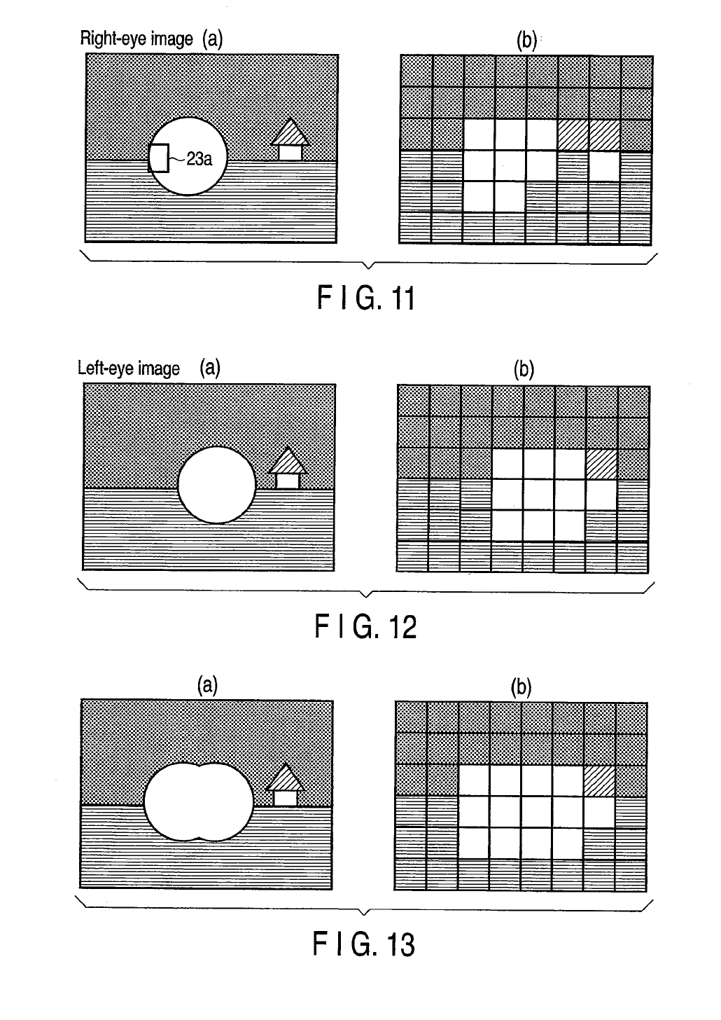

Here, (a) in FIG. 11 illustrates a right-eye image displayed on the liquid crystal display panel 17 and (b) in FIG. 11 illustrates light emission of each of the light sources 24 that make up the backlight 19 corresponding to this right-eye image. (a) in FIG. 12 illustrates a left-eye image displayed on the liquid crystal display panel 17 and (b) in FIG. 12 illustrates light emission of each of the light sources 24 that make up the backlight 19 corresponding to this left-eye image.

That is, in both the right- and left-eye images, the local dimming technique is applied so that in a high-luminous (brighter) part (indicated in white in (b) of FIGS. 11 and 12), the emitted light amount of a corresponding light source 24 is great (light is bright) and in a low-luminous (darker) part (indicated in black in (b) of FIGS. 11 and 12), the emitted light amount of a corresponding light source 24 is small (light is dark).

Here, as described above, the right- and left-eye images in the stereoscopic vision have parallax corresponding to the distance between the eyes. In other words, as is clear from comparison between the right-eye image as illustrated in (a) of FIG. 11 and the left-eye image as illustrated in (a) of FIG. 12, the position of a subject existing in the vicinity (white circle in (a) of FIGS. 11 and 12) is shifted left in the right-eye image and shifted right in the left-eye image, though the position of a subject far away (house in (a) of FIGS. 11 and 12) is not much different between the right- and left-eye images.

Therefore, when attention is paid to a given area 23a in the right-eye image illustrated in (a) of FIG. 11, it is found that there exists a high-luminous subject indicated by the while circle in the right-eye image, but the high-luminous subject indicated by white circle does not exist in the left-eye image. This means that with reference to the backlight 19, the light source 24 corresponding to the given area 23a is controlled to emit a greater amount of light (be brighter) when the right-eye image is displayed and to emit a smaller amount of light (be darker) when the left-eye image is displayed.

Then, since in the stereoscopic vision, the right- and left-eye images are displayed alternately, the light source 24 corresponding to the above-mentioned given area 23a is controlled to emit a large amount of light and a small amount of light alternately.

Therefore, it is assumed that when the above-mentioned serial processing module 14 outputs the right- and left-eye image signals alternately, in the above-mentioned given area 23a, a maximum value of luminous obtained from the right-eye image and a maximum value of luminous obtained from the left-eye image are supplied simply alternately to the LPF 35.

Then, the values of luminous supplied to the input terminal 35a of the LPF 35 become greatly different, as denoted by the solid line A in (c) of FIG. 10, between when the right-eye image is displayed and when the left-eye image is displayed. Then, in the LPF 35, as described above, the input value is subjected to the filtering processing in the time axis direction and output as an output value that changes gradually in the time axis direction.

Therefore, the output value from the LPF 35 is, as denoted by the dotted line B in (c) of FIG. 10, reduced to be about a half of the input value and this output value of the LPF 35 becomes an emitted light amount control value for controlling the emitted light amount of the corresponding light source 24 in the above-mentioned given area 23a. Hence, the emitted light amount of the light source 24 is not increased enough and the user feels that the display image in the given area 23a is dark.

Then, like the above-mentioned backlight controller 16, in each of the plural areas 23 (j×k areas) divided from the panel surface of the liquid crystal display panel 17, a substantially greater value of a maximum value of luminous in the right-eye image and a maximum value of luminous in the left-eye image is selected and the selected luminous value is output to the LPF 35.

This is because, as illustrated in (a) of FIG. 13, an image is generated by selecting an image of higher luminous in each area 23 out of the right-eye image as illustrated in (a) of FIG. 11 and the left-eye image as illustrated in (a) of FIG. 12. Then, as illustrated in (b) of FIG. 13, the emitted light amount of each light source 24 of the backlight 19 is controlled corresponding to the image illustrated in (a) of FIG. 13.

Thus, since a substantially greater value of the maximum value of luminous in the right-eye image and the maximum value of luminous in the left-eye image is supplied to the LPF 35, even if the maximum value of luminous in the right-eye image and the maximum value of luminous in the left-eye image are greatly different from each other as denoted by the dotted line A in (b) of FIG. 10 in the above-mentioned predetermined area 23a, the luminous value input to the LPF 35 becomes the greater luminous value as denoted by the solid line B in (b) of FIG. 10.

With this structure, the output value of the LPF 35 is prevented from being reduced to the input value or less as denoted by the dotted line C in (b) of FIG. 10 even when the filtering processing is performed in the time axis direction, and the emitted light amount of each light source 24 at the position corresponding to the above-mentioned predetermined area 23a can be sufficiently larger and it becomes possible to prevent the user from feeling darkness of the display image in the predetermined area 23a.

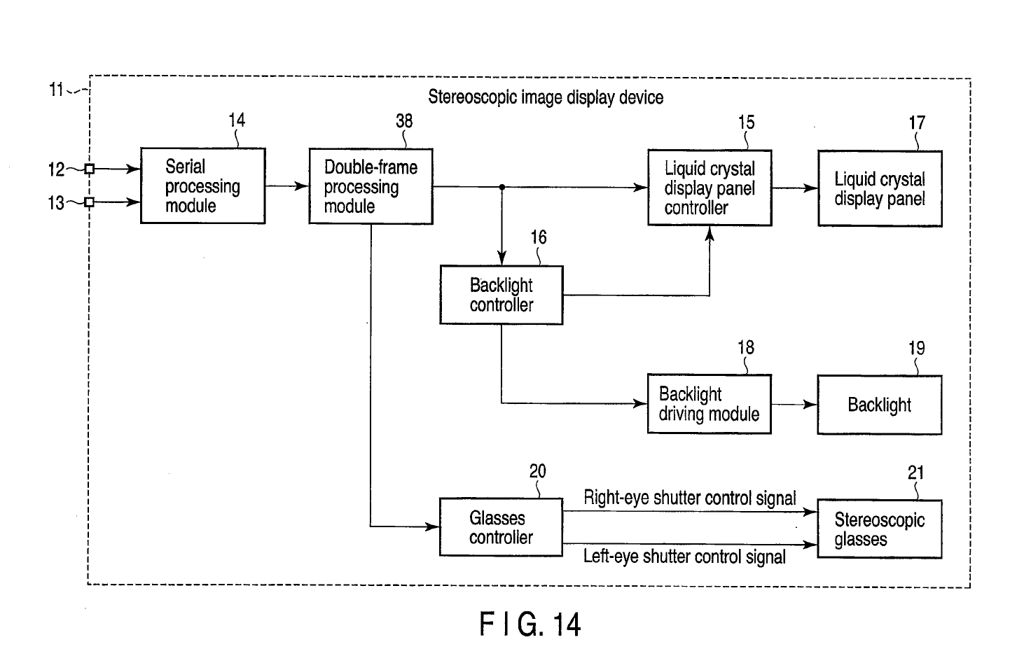

FIG. 14 illustrates a modification of the stereoscopic image display device 11 explained in this embodiment. In FIG. 14, the same parts as those in FIG. 1 are denoted by the same reference numbers for explanation. The right- and left-eye image signals output alternately from the serial processing module 14 are supplied to a double-frame processing module 38. This double-frame processing module 38 has a function to receive right- and left-eye image signals alternately and output two right-eye image signals and two left-eye image signals at double speed.

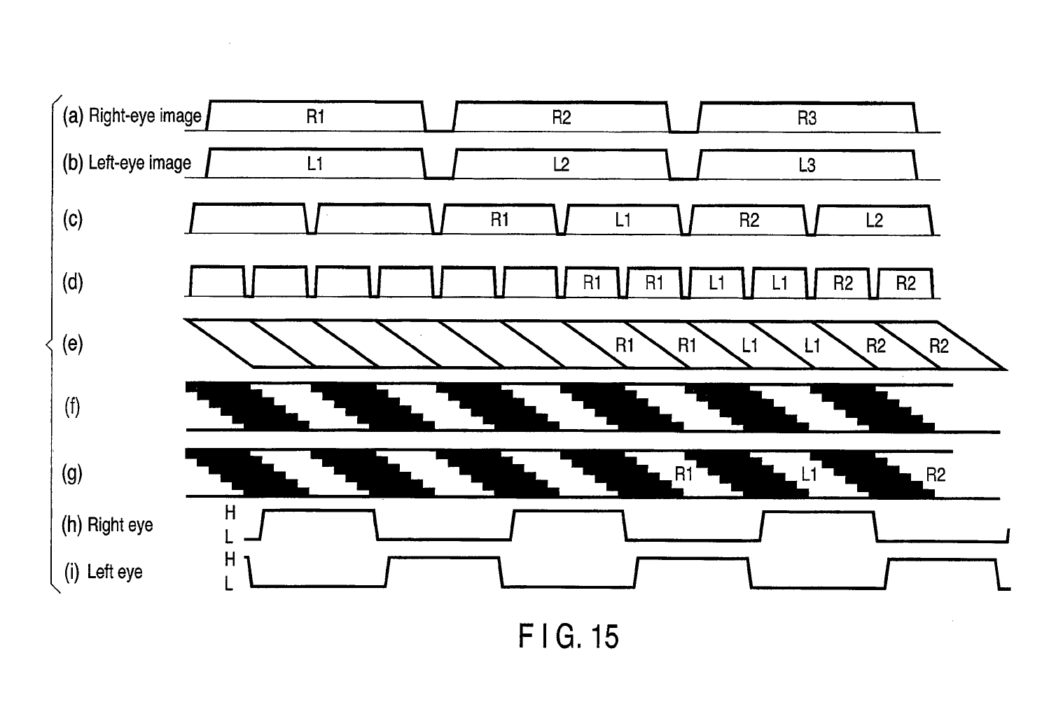

In other words, it is assumed that the above-mentioned input terminal 12 receives the right-eye image signals R1, R2, . . . , at the frame period of 1/60 second as illustrated in (a) of FIG. 15 and the above-mentioned input terminal 13 receives the left-eye image signals L1, L2, . . . , at the frame period of 1/60 second as illustrated in (b) of FIG. 15.

Then, the serial processing module 14 outputs, as illustrated in (c) of FIG. 15, right- and left-eye image signals alternately at the frame period of 1/120 second, and the double-frame processing module 38 outputs, as illustrated in (d) of FIG. 15, two right-eye image signals and two left-eye image signals alternately at the frame period of 1/240 second.

In (e), (f) and (g) of FIG. 15, the vertical axis denotes the height direction of the screen. The two right-eye image signals and two left-eye image signals output alternately from the double-frame processing module 38 at the frame period of 1/240 second are, as illustrated in (e) of FIG. 15, sequentially written per frame in the liquid crystal display panel 17.

In this case, writing of image signals for each frame into the liquid crystal display panel 17 is performed sequentially line by line from the upper side to the lower side of the screen. Therefore, writing to the undermost horizontal line is performed just before writing to a next frame is started. Here, since liquid crystal is a hold type device, it holds the same signals until the next writing.

The backlight 19 is turned off per frame as illustrated in (f) of FIG. 15. In this case, the plural light sources 24 that make up the backlight 19 are controlled to be turned on and off in each of the areas 23 in synchronization with writing of the image signals in the liquid crystal display panel 17.

Then, with use of the backlight 19 controlled as illustrated in (f) of FIG. 15, the display image as illustrated in (g) of FIG. 15 obtained by illuminating the liquid crystal display panel 17 to which image signals are written as illustrated in (e) of FIG. 15, that is, an image with a one-frame black screen interposed between each right-eye image and each left-eye image displayed alternately, is visually recognized by the user wearing the stereoscopic glasses 21.

In this case, the above-mentioned glasses controller 20 outputs, as illustrated in (h) of FIG. 15, a right-eye shutter control signal to open the right-eye shutter of the stereoscopic glasses 21 at the low level occurring when the black screen and its following right-eye image are displayed and to close the right-eye shutter of the stereoscopic glasses 21 at the high level occurring when the black screen and its following left-eye image are displayed.

In addition, the glasses controller 20 outputs, as illustrated in (i) of FIG. 15, a left-eye shutter control signal to open the left-eye shutter of the stereoscopic glasses 21 at the low level occurring when the black screen and its following left-eye image are displayed and to close the left-eye shutter of the stereoscopic glasses 21 at the high level occurring when the black screen and its following right-eye image are displayed.

When the operation explained with reference to FIG. 15 is performed, the maximum values of luminous stored in the right-eye maximum value storage area 34c1 and the left-eye maximum value storage area 34c2 of each of the maximum value storages 34c that make up the above-mentioned all-area maximum value storage 34 are updated every three frames.

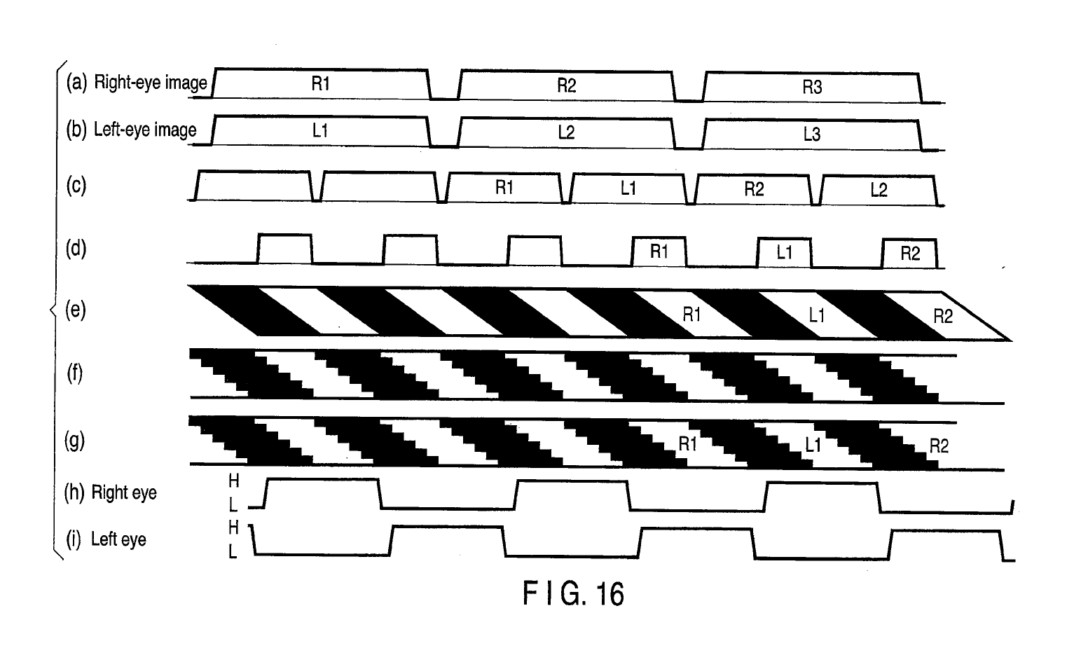

Further, FIG. 16 illustrates another operation example of the modification of the stereoscopic image display device 11 illustrated in FIG. 14. That is, the above-mentioned input terminal 12 receives right-eye image signals R1, R2, . . . , at the frame period of 1/60 second as illustrated in (a) of FIG. 16 and the above-mentioned input terminal 13 receives left-eye image signals L1, L2, . . . , at the frame period of 1/60 second as illustrated in (b) of FIG. 16.

Then, the serial processing module 14 outputs, as illustrated in (c) of FIG. 16, right- and left-eye image signals alternately at the frame period of 1/120 second and the double-frame processing module 38 outputs, as illustrated in (d) of FIG. 16, right- and left-eye image signals alternately with a black screen interposed therebetween at the frame period of 1/240 second.

In (e), (f) and (g) of FIG. 16, the vertical axis denotes the height direction of the screen. The right- and left-eye image signals alternately output from the double-frame processing module 38 with the black screen interposed therebetween at the frame period of 1/240 second are written in the liquid crystal display panel 17 on a per-frame basis, as illustrated in (e) of FIG. 16.

In this case, writing of image signals for each frame into the liquid crystal display panel 17 is sequentially performed horizontal line by line from the upper side to the lower side of the screen. Therefore, wiring to the undermost horizontal line is performed just before writing to the next frame is started. Here, the liquid crystal is a hold type device and therefore, holds the same signals until the next writing.

The backlight 19 is turned off on a per-frame basis, as illustrated in (f) of FIG. 16. In this case, the plural light sources 24 that make up the backlight 19 are controlled to turn on and off corresponding to the respective areas 23, in synchronization with writing of image signals to the liquid crystal display panel 17.

Then, with the backlight 19 controlled as illustrated in (f) of FIG. 16, a display image illustrated in (g) of FIG. 16 obtained with illumination of the liquid crystal display panel 17 in which image signals are written as illustrated in (e) of FIG. 16, that is, an image in which a black screen for one frame is interposed between right- and left-eye images that are displayed alternately, is visually recognized by the user wearing the stereoscopic glasses 21.

In this case, as illustrated in (h) of FIG. 16, the above-mentioned glasses controller 20 outputs a right-eye shutter control signal to open the right-eye shutter of the stereoscopic glasses 21 at the low level occurring just when the black screen and its following right-eye image are displayed and to close the right-eye shutter of the stereoscopic glasses 21 at the high level occurring just when the black screen and its following left-eye image are displayed.

In addition, as illustrated in (i) of FIG. 16, the glasses controller 20 outputs a left-eye shutter control signal to open the left-eye shutter of the stereoscopic glasses 21 at the low level occurring just when the black screen and its following left-eye image are displayed and to close the left-eye shutter of the stereoscopic glasses 21 at the high level occurring just when the black screen and its following right-eye image are displayed.

As explained with reference to (g) of FIG. 15 and (g) of FIG. 16, as the black screen is interposed between the right- and left-eye images that are displayed alternately, it becomes possible to make the user visually recognize high-contract distinct stereoscopic images.

Further, in the above-mentioned embodiments, the image is displayed with use of the liquid crystal display panel 17. However, the image display panel is not limited to a liquid crystal type, and the present invention may be applied to a wide range of panels as long as they are for displaying images with use of illumination light from the backlight 19.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A stereoscopic image display device comprising:
a display panel configured to alternately display a first image and a second image both for stereoscopic vision having a mutual parallax;
a lighting module which comprises a plurality of light sources arranged corresponding to a surface of the display panel and is configured to apply illumination light to a backside surface of the display panel;
an obtaining module configured to obtain a greater value of a maximum value of luminous of the first image displayed and a maximum value of luminous of the second image displayed in each of a plurality of areas divided from the surface of the display panel corresponding to said plurality of light sources of the lighting module;
a filtering module configured to perform filtering processing in a time axis direction on the value of luminous in each of said plurality of areas obtained by the obtaining module; and
a controller configured to use the value of luminous in each of said plurality of areas, on which value the filtering processing is performed in the filtering module, as a basis to control an emitted light amount of the light source corresponding to the area.

2. The stereoscopic image display device of claim 1, wherein the obtaining module comprises:
a first obtaining module configured to obtain the maximum value of luminous of the first image displayed in each of said plurality of areas divided from the surface of the display panel;
a second obtaining module configured to obtain the maximum value of luminous of the second image displayed in each of said plurality of areas divided from the surface of the display panel; and
a selecting module configured to select and output the greater value of the maximum value of luminous obtained in the first obtaining module and the maximum value of luminous obtained in the second obtaining module in each of said plurality of areas divided from the surface of the display panel.

3. The stereoscopic image display device of claim 1, wherein the obtaining module comprises:
a first obtaining module configured to obtain the maximum value of luminous of the first image displayed in each of said plurality of areas divided from the surface of the display panel;
a first storage configured to store the maximum value of luminous in each of said plurality of areas obtained in the first obtaining module;
a second obtaining module configured to obtain the maximum value of luminous of the second image displayed in each of said plurality of areas divided from the surface of the display panel;
a second storage configured to store the maximum value of luminous in each of said plurality of areas obtained in the second obtaining module; and
a selecting module configured to select and output the greater value of the maximum value of luminous stored in the first storage and the maximum value of luminous stored in the second storage in each of said plurality of areas divided from the surface of the display panel.

4. The stereoscopic image display device of claim 1, wherein the obtaining module is configured to, in each of said plurality of areas divided from the surface of the display panel, detect a maximum value of luminous among values of luminous of a plurality of pixels in each of horizontal lines included in the area and select a greatest value among maximum values of the respective horizontal lines detected.

5. The stereoscopic image display device of claim 1, wherein the controller comprises a storage configured to store the value of luminous in each of said plurality of areas, on which value the filtering processing is performed in the filtering module, as an emitted light amount control value to control the emitted light amount of the light source corresponding to the area.

6. The stereoscopic image display device of claim 1, wherein the controller comprises a storage configured to store the value of luminous in each of said plurality of areas, on which value the filtering processing is performed in the filtering module, as an emitted light amount control value to control the emitted light amount of the light source corresponding to the area, and
the filtering module is configured to perform, on the value of luminous obtained in the obtaining module in each of said plurality of areas divided from the surface of the display panel, the filtering processing based on the emitted light amount control value of the corresponding area stored in the storage.

7. The stereoscopic image display device of claim 1, wherein a black screen is interposed between the first image and the second image that are displayed alternately in the display panel.

8. The stereoscopic image display device of claim 1, wherein the display panel comprises a liquid crystal display panel and each of the light sources comprises an LED.

9. A stereoscopic image display method comprising:
alternately displaying a first image and a second image both for stereoscopic vision having a mutual parallax on a display panel;
using a lighting module which comprises a plurality of light sources arranged corresponding to a surface of the display panel to apply illumination light to a backside surface of the display panel;
obtaining a greater value of a maximum value of luminous of the first image displayed and a maximum value of luminous of the second image displayed in each of a plurality of areas divided from the surface of the display panel corresponding to said plurality of light sources of the lighting module;
performing filtering processing in a time axis direction on the obtained value of luminous in each of said plurality of areas; and
using the value of luminous in each of said plurality of areas, on which value the filtering processing is performed, as a basis to control an emitted light amount of the light source corresponding to the area.
